(19) United States
(12) Patent Application Publication
(10) Pub. No.: US 2017/0152434 A1
(43) Pub. Date: Jun. 1, 2017

(54) MIXTURE OF HTO/HF ACIDS TO STIMULATE SANDSTONE FORMATIONS

(71) Applicant: BAKER HUGHES INCORPORATED, Houston, TX (US)

(72) Inventors: Jennifer L. Cutler, Houston, TX (US); Ahmed Gomaa, Spring, TX (US); Xiaolan Wang, Spring, TX (US); Marty J. Usie, Youngsville, LA (US); Harold G. Hudson, The Woodlands, TX (US)

(73) Assignee: BAKER HUGHES INCORPORATED, Houston, TX (US)

(21) Appl. No.: 15/365,372

(22) Filed: Nov. 30, 2016

Related U.S. Application Data
(60) Provisional application No. 62/261,729, filed on Dec. 1, 2015.

(51) Int. Cl. C09K 8/74; E21B 43/25

(52) U.S. Cl. CPC C09K 8/74; E21B 43/25

(57) ABSTRACT

A composition of a mixture of at least three organic acids with hydrofluoric acid (HF) generates a system that stimulates subterranean sandstone formations, enhances the permeability thereof, and therefore increases the formation's productivity. This system has a very low corrosion rate and may start with a pH greater than about 2. It is suitable for high temperature wells (greater than about 250° F. (121° C.)) and wells completed with specialized metal alloys. The system is hydrochloric acid-free and is compatible with high clay formations. Particularly suitable organic acids include, but are not necessarily limited to, the dicarboxylic acids succinic acid, glutaric acid, adipic acid, and mixtures thereof. Alternatively, the hydrofluoric acid is supplied by a substance that hydrolyzes to HF (e.g. ammonium bifluoride) and boric acid is included to delay the hydrolyzing to HF.

### CROSS-REFERENCE TO RELATED APPLICATION

This application claims the benefit of U.S. Provisional Patent Application No. 62/261,729 filed Dec. 1, 2015, incorporated herein by reference in its entirety.

### TECHNICAL FIELD

The present invention relates to acidizing treatment fluids used during hydrocarbon recovery operations, and more particularly relates, in one non-limiting embodiment, to acidizing methods during hydrocarbon recovery operations that have reduced corrosivity of equipment.

### BACKGROUND

Hydrocarbons sometimes exist in a formation but cannot flow readily into the well because the formation has very low permeability. Acidizing wells is a conventional process for increasing or restoring the permeability of subterranean formations so as to facilitate the flow of oil and gas from the formation into the well. This process involves treating the formation with an acid to dissolve fines and carbonate scale plugging or clogging the pores, thereby opening the pores and other flow channels and enhancing the permeability of the formation. Continued pumping forces the acid into the formation, where it etches channels or wormholes. These channels provide ways for the formation hydrocarbons to enter the well bore.

Conventional acidizing fluids, such as hydrochloric acid or a mixture of hydrofluoric and hydrochloric acids, have high acid strength and quick reaction with fines and scale nearest the well bore, and have a tendency to corrode tubing, casing and downhole equipment, such as gravel pack screens and downhole pumps, especially at elevated temperatures. In addition, above 200° F. (92° C.), HCl is not recommended because of its destructive effect on the rock matrix. Due to the type of metallurgy, long acid contact times and high acid sensitivity of the formations, removal of the scale with hydrochloric acid and hydrochloric acid mixtures has been largely unsuccessful. There is a need to find an acid fluid system to dissolve the scale and remove the source of the fines through acidizing the surrounding formation and reduce the corrosion of downhole equipment, particularly for high temperature wells.

It would be desirable if a composition and method could be devised to overcome some of the problems in the conventional acidizing methods and fluids.

### SUMMARY

There is provided, in one non-limiting form, a method for enhancing the permeability of a subterranean sandstone formation, which method includes injecting an acid composition into the subterranean sandstone formation. The acid composition includes, but is not necessarily limited to, a mixture of at least three carboxylic acids, a substance that hydrolyzes to hydrofluoric acid, and boric acid, where the pH of the acid composition ranges from about 2 to about 5 and there is an absence of hydrochloric acid. The method further includes contacting the subterranean sandstone formation with the acid composition for an effective period of time to enhance the permeability of the formation.

### BRIEF DESCRIPTION OF THE DRAWINGS

FIG. 1 is a graph of differential pressure in pounds per square inch (psi) plotted as a function of pore volume (PV) throughput for Example 1, and

FIG. 2 is a graph of differential pressure in psi plotted as a function of pore volume (PV) throughput for Example 2.

### DETAILED DESCRIPTION

Provided is an organic acid/hydrofluoric acid fluid system and method for matrix acidization of high temperature subterranean sandstone formations penetrated by a well bore. “High temperature” is defined herein as a temperature greater than about 250° F. (121° C.). An important advantage of the acid system that is designed for high temperature is its ability to have a relatively low corrosion rate at this high temperature. Therefore, in some alternate embodiments, it may be used at low temperature when a very low corrosion rate is needed. Another advantage of the system is that the acid composition can be flowed back with a minimum corrosion rate to completion or surface equipment that is exposed to the acid composition.

The acid composition contains at least one carboxylic acid, if not a mixture of carboxylic acids, and in particular a mixture of three carboxylic acids, a substance that hydrolyzes to hydrofluoric acid, and boric acid, the latter which is included to delay the release of hydrofluoric acid from the substance.

In more detail, suitable carboxylic acids include, but are not necessarily limited to, monocarboxylic acids including formic acid, acetic acid, propionic acid, butyric acid, valeric acid, caproic acid, enanthic acid, caprylic aid, pelargonic acid, capric acid, undecylic acid, lauric acid, tridecylic acid, myristic acid, pentadecanoic acid, palmitic acid, margaric acid, steric acid, arachidic acid, and mixtures thereof; dicarboxylic acids including oxalic acid, malonic acid, succinic acid, glutaric acid, adipic acid, pimelic acid, suberic acid, azelaic acid, sebacic acid, and mixtures thereof; and tricarboxylic acids including citric acid, isocitric acid, aconitic acid, propane-1,2,3-tricarboxylic acid, trimesic acid, and mixtures thereof.

It has been discovered that a particularly useful organic acid fluid contains at least one water-soluble dicarboxylic acid having a relatively low molecular weight, that is, has a formula weight of 175 or less. Suitable dicarboxylic acids therefore include, but are not necessarily limited to, oxalic acid (ethanedioic acid), malonic acid (propanedioic acid), succinic acid (butanedioic acid), glutaric acid (pentanedioic acid), adipic acid (hexanedioic acid), pimelic acid (heptanedioic acid), and mixtures thereof. In another, useful but non-restrictive embodiment, the dicarboxylic acids in the mixture are selected from the group consisting of succinic acid, glutaric acid, adipic acid, and mixtures thereof. Interestingly, glutaric acid, succinic acid, and adipic acid were mentioned individually as components for corrosion inhibitors for ferrous metals, according to U.S. Pat. No. 4,512,552, incorporated herein by reference in its entirety. Mixtures of succinic acid, glutaric acid, and adipic acid are generally available as a by-product stream. In one non-limiting embodiment, this mixture of organic acids has from about 40 to about 70 wt % of glutaric acid, from about 10 to about 30 wt % of succinic acid, and from about 10 to about 30 wt % of adipic acid.

The organic acid fluid systems described herein can effectively stimulate production in subterranean carbonate formations and dissolve carbonate scale, and these organic acids mixed with hydrofluoric acid can effectively remove fines to recover production in sandstone formations at elevated temperatures. These aqueous treating fluids have very low corrosion of the tubing, casing and downhole equipment.

Based on the properties of the suitable organic acids, the aqueous treating compositions of acid compositions comprising acid compositions having organic acids along with HF acid or substances that hydrolyze to hydrofluoric acid, can be used as acid compositions to stimulate high temperature wells, according to the methods described herein. In addition to its reactivity, the acid system, particularly when combined with corrosion inhibitor, exhibits very low corrosion at high temperatures.

As noted, hydrofluoric acid is used together with the one or more organic acids. Hydrofluoric acid is used to aid in dissolving silicates. In particular, the method may employ a substance that hydrolyzes to hydrofluoric acid. Suitable substances include, but are not necessarily limited to, ammonium bifluoride (ABF), alkali metal fluorides and bifluorides (where the alkali metal is typically sodium, potassium or the like) as well as transition metal fluorides (for instance hexafluorotitanate salts and the like) and mixtures thereof. Boric acid is used to delay the release of the HF acid system (the substance that hydrolyzes to HF acid) so that the HF acid release is retarded and the acid composition may be injected further or deeper into the subterranean sandstone formation before the HF acid is released. In one non-limiting embodiment, the weight ratio of ABF to boric acid ranges from about 0.1 independently to 5; alternatively from about 1.5 independently to about 3. In one non-restrictive version the molar ratio of boric acid to ABF is about 2. When the word “independently” is used with respect to a range, it means that any lower threshold may be used with any upper threshold to give a suitable alternative range. It has been discovered that ammonium fluoride does not work because of the boric acid solubility that occurs.

The application range for the HF acid, or substance that hydrolyzes to HF, in the aqueous treating fluid may range from about 0.1 independently to about 3 wt % in one non-limiting embodiment; alternatively from about 0.5 independently to about 1 wt %, based on the acid composition. In another non-limiting embodiment if the concentration of HF in the aqueous treating fluid is kept at about 1 wt % or less, it is expected that it will be possible to quickly neutralize the HF even in a low calcium content environment.

The pH of the acid composition ranges from about 2 independently to about 5; alternatively from about 3 independently to about 4.5.

In one non-limiting embodiment, the method further comprises injecting the acid composition into the subterranean sandstone formation through metal equipment where the corrosion rate of the metal equipment is at least less than 0.02 lb/ft² for coiled tubing or at least less than 0.05 lb/ft² for other grade of metal equipment at a given evaluated temperature. Coiled tubing is typically formed from high-strength, low-alloy steels. Thus, if coiled tubing present is of a first grade of steel, other metal equipment can be of an other grade steel different from the first grade of steel.

It will be appreciated that it is challenging to specify with precision the amount of dicarboxylic acid that must be used to effectively acidize a particular subterranean formation. A number of complex, interrelated factors must be taken into account that would affect such a proportion, including but not necessarily limited to, the temperature of the formation, the pressure of the formation, the particular fines and scales present in the formation (e.g. calcium carbonate, silicates, and the like), the particular dicarboxylic acid(s) used, the expected contact time of the acid composition with the formation, etc. Nevertheless, to give some idea of suitable proportions, in one non-restrictive version, the acid composition is present from about 0.1 independently to about 3 wt % of an aqueous treating fluid; alternatively from about 0.25 independently to about 1 wt %, where method comprises injecting the aqueous treating fluid into the subterranean sandstone formation and contacting the subterranean sandstone formation with the aqueous treating fluid. In another non-limiting embodiment, the mixture of three carboxylic acids is present in an aqueous treating fluid in a proportion of from about 1 independently to about 5 wt %; alternatively from about 1.5 independently to about 4.5 wt %; in another non-limiting version from about 2 independently to about 4 wt %.

For stimulation treatments, contact times are determined from the maximum pumping rate that does not cause the downhole pressure to exceed the fracturing pressure. This type of treatment is called a “matrix” acid job.

For scale/fines removal procedures, contact times are based on laboratory tests, but usually range from about 0.5 hour to about 2 hour with the most common time being about 0.5 hour.

Suitable solvents or diluents for the acid compositions of the method include, but are not necessarily limited to, water, methanol, isopropyl alcohol, alcohol ethers, aromatic solvents, and mixtures thereof. In one nonlimiting embodiment, the composition has an absence of monocarboxylic acids and/or an absence of tricarboxylic acids. Alternatively, in another embodiment, the acid composition has an absence of quaternary ammonium compounds and/or an absence of sulfur-containing corrosion inhibitor activator (e.g. thioglycolic acid, alkali metal sulfonate, etc.). As noted, a goal is to avoid the use of strong mineral acids, such as HCl and/or H₂SO₄, so these acids should be absent from the acid composition in one non-limiting embodiment. The acid compositions are intended to replace the mineral acid systems previously used, in one non-limiting aspect of the method. The use of hydrofluoric acid (noted above) is an exception to these considerations about mineral acids.

The aqueous treating fluid may optionally contain other conventional additives including, but not necessarily limited to, corrosion inhibitors, iron control agents, clay inhibitors, non-emulsifiers, H₂S scavengers, corrosion inhibitor intensifiers, anti-sludge agents, biocides, solvents, and/or foaming agents.

The invention will be further illustrated with respect to certain experiments, but these examples are not intended to limit the invention, but only to further describe it in certain specific, non-limiting embodiments.

For Examples 1 and 2 the main acid stage, which included the HF acid, and the pre-/post-flush acid stages had the compositions of Tables I and II, respectively.

TABLE I
Main Acid Stage (including HF)
HTO/HF acid - 5 wt %: 1 wt %

| Component, units | Amount |
|---|---|
| Water, ml | 87.42 |
| ABF, gm | 1.50 |
| HTO, gm | 5.00 |
| Boric acid, gm | 0.68 |
| Cl-27, ml | 0.50 |
| Fe-300 L | 1.90 |
| Cm-10, ml | 0.50 |
| Initial pH | 3.30 |

TABLE II
Pre-/Post Flush Acid Stage
HTO acid (5 wt %)

| Component, units | Amount |
|---|---|
| Water, ml | 92.1 |
| HTO, gm | 5.0 |
| Cl-27, ml | 0.50 |
| Fe-300 L, ml | 1.90 |
| Cm-10, ml | 0.50 |
| Initial pH | 2.50 |

### GLOSSARY

HTO Acid—a mixture of glutaric acid, succinic acid and adipic acid.
Cl-27—a corrosion inhibitor available from Baker Hughes.
Fe-300L—citric acid used as an iron control agent available from Baker Hughes.
CM-10—a permanent clay control agent available from Baker Hughes; this helps keep naturally expandable clays from expanding.

### EXAMPLE 1

Example 1 used the acid stages of Tables I and II to treat a Berea sandstone 5-5A core having a K_{N2}=116 millidarcies (md) and φ=17.2% at a temperature of 230° F. (110° C.). K_{N2} is the permeability to dry (not humidified) nitrogen, clean and dry sample. φ refers to porosity; pore volume as a percentage of total volume. The pore volumes (PVs) for the pre-, main, and post-flush stages for Example 1 were as follows:
4 PV Pre-Flush (HTO); Flow Rate Q=3 ml/min
8 PV Main Stage (HTO+1% HF); Flow Rate Q=2 ml/min
3.5 PV Post-Flush (HTO); Flow Rate Q=3 ml/min

The Differential Pressure as a Function of Pore Volume

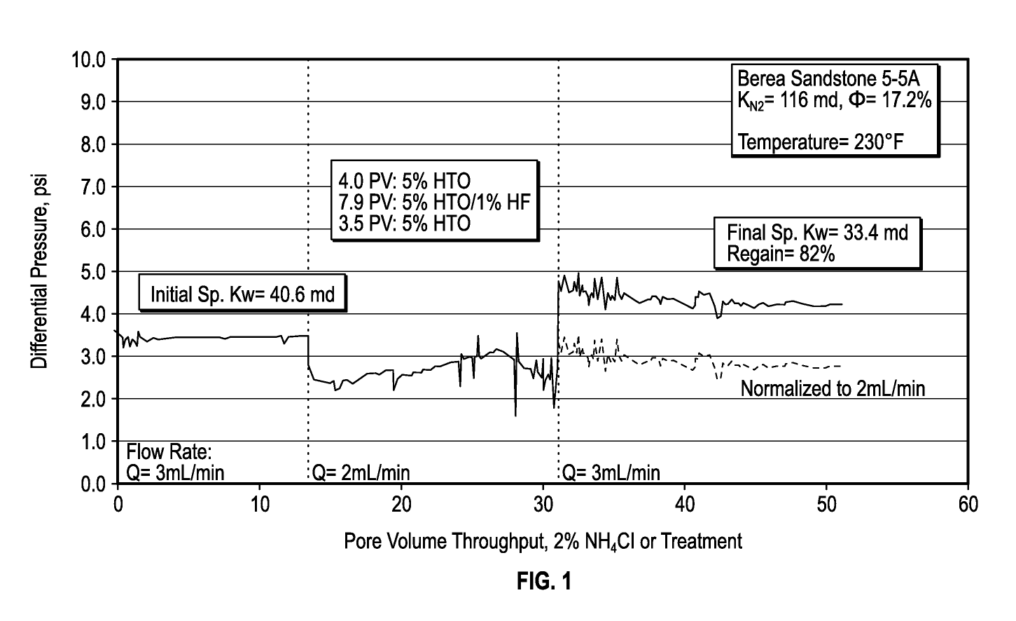

Throughput is plotted in FIG. 1. The vertical lines divide the three stages from left to right. Specific Permeability to Water—2% NH₄Cl in these tests, Sp·K_{w}, is reported in millidarcies, and for Example 1 initial Sp·K_{w} was 40.6 md and final Sp·K_{w}, was 33.4 md. The Regain Permeability for Example 1 was 82%. Analysis of the fluid sample that came out of the core after each stage is reported in Table III.

TABLE III
Fluid Sample Analysis from Core from Each Stage - Example 1

| Sample | pH | Al | Ca | Fe | Mg | Si |
|---|---|---|---|---|---|---|
| 5% HTO Preflush 4 PV | 7.23 | 2 | 146 | 14 | 26 | 5 |
| 5% HTO/1% HF 8 PV | 2.81 | 315 | 607 | 1090 | 142 | 243 |
| 5% HTO Preflush 4 PV | 3.35 | 938 | 11 | 2144 | 6 | 1053 |
| Regain H2O 2% NH4Cl | 3.83 | 3 | 91 | 260 | 43 | 137 |

For Example 1, a permeability reduction was noted because the injected volume was less than what was needed as the pressure drop was going to be decreased (the regain permeability was 82%). Therefore, by increasing the volume in Example 2, a permeability enhancement was observed.

### EXAMPLE 2

Example 2 used the acid stages of Tables I and II to treat a Berea sandstone 3B core having a K_{N2}=160 millidarcies (md) and φ=17.8% at a temperature of 230° F. (110° C.). The PVs for the pre-, main, and post-flush stages for Example 2 were as follows:
6.2 PV Pre-Flush (HTO); Flow Rate Q=6 ml/min
12 PV Main Stage (HTO+1% HF); Flow Rate Q=2 ml/min
6 PV Post-Flush (HTO); Flow Rate Q=6 ml/min

The Differential Pressure as a Function of Pore Volume

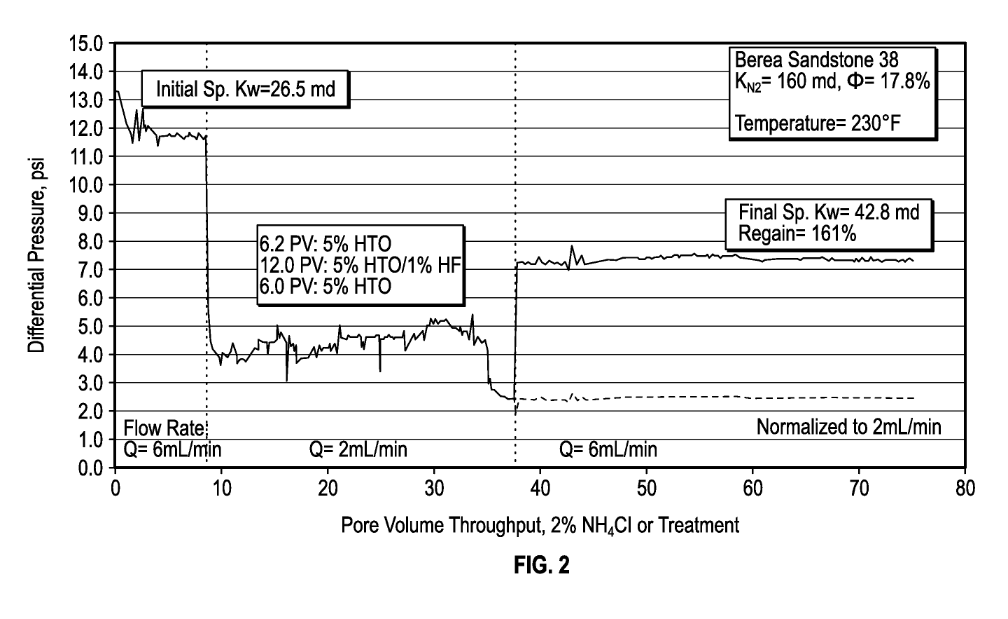

Throughput is plotted in FIG. 2. Again, the vertical lines divide the three stages from left to right. For Example 2 initial Sp·K_{w} was 26.5 md and final Sp·K_{w}, was 42.8 md. The Regain Permeability for Example 1 was 161%, indicating enhancement. Analysis of the fluid sample that came out of the core after each stage is reported in Table IV.

TABLE IV
Fluid Sample Analysis from Core from Each Stage - Example 2

| Sample | pH | Al | Ca | Fe | Mg | Si |
|---|---|---|---|---|---|---|
| 5% HTO Preflush 6 PV | 3.02 | 49 | 273 | 212 | 50 | 33 |
| 5% HTO/1% HF 12 PV | 3.08 | 309 | 35 | 1305 | 85 | 727 |
| 5% HTO Preflush 6 PV + Brine | 3.15 | 494 | 27 | 1094 | 54 | 743 |
| Berea 58 Overflush NH₄Cl | 3.21 | 38 | 80 | 64 | 31 | 33 |

For Example 2, analysis of the effluent samples in Table IV shows that:
the pre-flush was able to remove the majority of the calcium;
during the main acid and post-flush stages, there was significant concentration increases in Al, Fe and Si, which indicated that the HF started to dissolve silica and clay; and
the pH of the effluent sample that came out of the experiment was between 3.02 and 3.21; because in this experiment a limited core length was used as compared to a real formation length, therefore, it is believed that a further increase in the pH will be obtained in actual formation treatment because of increased acid-formation contact time and dilution during the flow back.

In the foregoing specification, the invention has been described with reference to specific embodiments thereof, and has been demonstrated as effective in providing an acidizing treatment fluid that can stimulate sandstone formations and increase their productivity. The new acid system has a very low corrosion rate and may start with a pH greater than 3. It has low corrosivity with respect to the iron-alloy materials and equipment it comes into contact with. This system may be used to target high temperature wells, and/or wells that are completed with specialized metallurgies. This sandstone acid system is HCl acid-free and is compatible with high clay formations. A “high clay formation” contains at least 15 weight % or more clay minerals.

However, it will be evident that various modifications and changes can be made thereto without departing from the broader scope of the method as set forth in the appended claims. Accordingly, the specification is to be regarded in an illustrative rather than a restrictive sense. For example, specific combinations of monocarboxylic acids, dicarboxylic acids, tricarboxylic acids, HF and substances that hydrolyze to HF, and other components falling within the claimed parameters, but not specifically identified or tried in a particular composition or under specific conditions, are anticipated to be within the scope of the method.

The present invention may suitably comprise, consist or consist essentially of the elements disclosed. For instance, there may be provided a method for enhancing the permeability of a subterranean sandstone formation consisting essentially of or consisting of injecting an acid composition into the subterranean sandstone formation where the acid composition comprises, consists essentially of, or consists of a mixture of at least three carboxylic acids, a substance that hydrolyzes to hydrofluoric acid, and boric acid; and where: the pH of the acid composition ranges from about 2 to about 5, and there is an absence of hydrochloric acid; and where the method further consists essentially of or consists of contacting the subterranean sandstone formation with the acid composition for an effective period of time to enhance the permeability of the formation.

As used herein, the terms “comprising,” “including,” “containing,” “characterized by,” and grammatical equivalents thereof are inclusive or openended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for enhancing the permeability of a subterranean sandstone formation comprising:
injecting an acid composition into the subterranean sandstone formation
where the acid composition comprises:
a mixture of at least three carboxylic acids;
a substance that hydrolyzes to hydrofluoric acid; and
boric acid; and
where:
the pH of the acid composition ranges from about 2 to about 5; and
there is an absence of hydrochloric acid; and
contacting the subterranean sandstone formation with the acid composition for an effective period of time to enhance the permeability of the formation.

2. The method of claim 1 where in the mixture, the carboxylic acids are selected from:
the group of monocarboxylic acids selected from the group consisting of formic acid, acetic acid, propionic acid, butyric acid, valeric acid, caproic acid, enanthic acid, caprylic aid, pelargonic acid, capric acid, undecylic acid, lauric acid, tridecylic acid, myristic acid, pentadecanoic acid, palmitic acid, margaric acid, steric acid, arachidic acid, and mixtures thereof; and
the group of dicarboxylic acids selected from the group consisting of oxalic acid, malonic acid, succinic acid, glutaric acid, adipic acid, pimelic acid, suberic acid, azelaic acid, sebacic acid, and mixtures thereof;
the group of tricarboxylic acids selected from the group consisting of citric acid, isocitric acid, aconitic acid, propane-1,2,3-tricarboxylic acid, trimesic acid, and mixtures thereof.

3. The method of claim 1 where the mixture comprises at least one dicarboxylic acid having a formula weight of 175 or less.

4. The method of claim 1 where the mixture comprises a dicarboxylic acid selected from the group consisting of succinic acid, glutaric acid, adipic acid, and mixtures thereof.

5. The method of claim 4 where the mixture comprises:
from about 40 to about 70 wt % of glutaric acid,
from about 10 to about 30 wt % of succinic acid, and
from about 10 to about 30 wt % of adipic acid.

6. The method of claim 1 where the contacting is conducted at a temperature greater than about 250° F. (121° C.).

7. The method of claim 1 where the acid composition is present in from about 0.1 to about 3 wt % of an aqueous treating fluid, where the method comprises injecting the aqueous treating fluid into the subterranean sandstone formation and contacting the subterranean sandstone formation with the aqueous treating fluid.

8. The method of claim 1 where the mixture of three carboxylic acids is present in from about 1 to about 5 wt % of an aqueous treating fluid, where the method comprises injecting the aqueous treating fluid into the subterranean sandstone formation and contacting the subterranean sandstone formation with the aqueous treating fluid.

9. The method of claim 1 where the substance that hydrolyzes to hydrofluoric acid is ammonium bifluoride (ABF) and the weight ratio of ABF to boric acid ranges from about 0.1 to 5.

10. The method of claim 1 where the method further comprises injecting the acid composition into the subterranean sandstone formation through metal equipment and the corrosion rate of the metal equipment is at least less than 0.02 lb/ft² for coiled tubing of a first grade steel or at least less than 0.05 lb/ft² for other grade steel.

11. A method for enhancing the permeability of a subterranean sandstone formation comprising:
injecting an acid composition into the subterranean sandstone formation
where the acid composition comprises:
a mixture of at least three carboxylic acids selected from:
the group of monocarboxylic acids selected from the group consisting of formic acid, acetic acid, propionic acid, butyric acid, valeric acid, caproic acid, enanthic acid, caprylic aid, pelargonic acid, capric acid, undecylic acid, lauric acid, tridecylic acid, myristic acid, pentadecanoic acid, palmitic acid, margaric acid, steric acid, arachidic acid, and mixtures thereof; and
the group of dicarboxylic acids selected from the group consisting of oxalic acid, malonic acid, succinic acid, glutaric acid, adipic acid, pimelic acid, suberic acid, azelaic acid, sebacic acid, and mixtures thereof;
the group of tricarboxylic acids selected from the group consisting of citric acid, isocitric acid, aconitic acid, propane-1,2,3-tricarboxylic acid, trimesic acid, and mixtures thereof;
a substance that hydrolyzes to hydrofluoric acid; and
boric acid; and
where:
the pH of the acid composition ranges from about 2 to about 5; and
there is an absence of hydrochloric acid; and
contacting the subterranean sandstone formation with the acid composition for an effective period of time to enhance the permeability of the formation at a temperature greater than about 250° F. (121° C.).

12. The method of claim 11 where the mixture comprises at least one dicarboxylic acid having a formula weight of 175 or less.

13. The method of claim 11 where the mixture comprises
from about 40 to about 70 wt % of glutaric acid,
from about 10 to about 30 wt % of succinic acid, and
from about 10 to about 30 wt % of adipic acid.

14. The method of claim 11 where the acid composition is present in from about 0.1 to about 3 wt % of an aqueous treating fluid, where the method comprises injecting the aqueous treating fluid into the subterranean sandstone formation and contacting the subterranean sandstone formation with the aqueous treating fluid.

15. The method of claim 11 where the mixture of three carboxylic acids is present in from about 1 to about 5 wt % of an aqueous treating fluid, where the method comprises injecting the aqueous treating fluid into the subterranean sandstone formation and contacting the subterranean sandstone formation with the aqueous treating fluid.

16. The method of claim 11 where the substance that hydrolyzes to hydrofluoric acid is ammonium bifluoride (ABF) and the weight ratio of ABF to boric acid ranges from about 0.1 to 5.

17. The method of claim 11 where the method further comprises injecting the acid composition into the subterranean sandstone formation through metal equipment and the corrosion rate of the metal equipment is at least less than 0.02 lb/ft² for coiled tubing of a first grade steel or at least less than 0.05 lb/ft² for other grade steel.

18. A method for enhancing the permeability of a subterranean sandstone formation comprising:
injecting an aqueous treating fluid comprising an acid composition into the subterranean sandstone formation, where the acid composition is present in from about 0.1 to about 3 wt % of an aqueous treating fluid and the acid composition comprises:
a mixture of at least three carboxylic acids selected from:
the group of monocarboxylic acids selected from the group consisting of formic acid, acetic acid, propionic acid, butyric acid, valeric acid, caproic acid, enanthic acid, caprylic aid, pelargonic acid, capric acid, undecylic acid, lauric acid, tridecylic acid, myristic acid, pentadecanoic acid, palmitic acid, margaric acid, steric acid, arachidic acid, and mixtures thereof; and
the group of dicarboxylic acids selected from the group consisting of oxalic acid, malonic acid, succinic acid, glutaric acid, adipic acid, pimelic acid, suberic acid, azelaic acid, sebacic acid, and mixtures thereof;
the group of tricarboxylic acids selected from the group consisting of citric acid, isocitric acid, aconitic acid, propane-1,2,3-tricarboxylic acid, trimesic acid, and mixtures thereof;
ammonium bifluoride (ABF); and
boric acid, where the weight ratio of ABF to boric acid ranges from about 0.1 to 5; and
where:
the pH of the acid composition ranges from about 2 to about 5; and
there is an absence of hydrochloric acid; and
contacting the subterranean sandstone formation with the aqueous treating fluid for an effective period of time to enhance the permeability of the formation at a temperature greater than about 250° F. (121° C.).

19. The method of claim 18 where the method further comprises injecting the acid composition into the subterranean sandstone formation through metal equipment and the corrosion rate of the metal equipment is at least less than 0.02 lb/ft² for coiled tubing of a first grade steel or at least less than 0.05 lb/ft² for other grade steel.
